(19) United States
(12) Patent Application Publication
(10) Pub. No.: US 2022/0401287 A1
(43) Pub. Date: Dec. 22, 2022

(54) BRAKE CABLE TAKE-UP DEVICE OF FOLDING MOBILITY AIDS

(71) Applicant: Xianwei Zeng, Xiamen (CN)

(72) Inventor: Xianwei Zeng, Xiamen (CN)

(21) Appl. No.: 17/406,085

(22) Filed: Aug. 19, 2021

(30) Foreign Application Priority Data
Jun. 18, 2021 (CN) 202121366706.1

(51) Int. Cl. A61H 3/04

(52) U.S. Cl. CPC A61H 3/04; A61H 2003/046; A61H 2201/0161

(57) ABSTRACT

The invention discloses a brake cable take-up device of folding mobility aids, comprising a frame, a brake cable, and a cable take-up device, wherein the cable take-up device comprises a first pin shaft, a coil spring, and a second pin shaft; the first pin shaft and the second pin shaft are arranged on the frame with a gap; the coil spring comprises an inner end and an outer end; the inner end is rotatably sleeved on the first pin shaft; the outer end is provided with a pulling ring; the brake cable extends from one end of the frame to the cable take-up device, and is movably wound around the second pin shaft and the pulling ring and then extends to the other end of the frame; the frame comprises a longitudinal pipe, and the lower end of the longitudinal pipe is connected with a horizontal pipe.

### BACKGROUND OF THE INVENTION

### 1. Field of the Invention

The invention relates to the technical field of mobility aids, in particular to a brake cable take-up device of folding mobility aids.

### 2. Description of the Related Art

With the improvement of people's living standards and the abundance of material resources, assistive and rehabilitation treatment equipment has become more and more popular in the market. The mobility aid is an auxiliary walking device that supports the body's weight and maintains the body's balance, which is widely used in people with limited mobility. A mobility aid generally comprises a mobility aid bracket; the mobility aid bracket is equipped with handlebars for palms and wheels for rolling on the ground. The handlebars are usually equipped with brake handles, and the wheels are usually equipped with brakes. The brake handle is connected to the brake to drive the brake movement through the brake cable arranged on the mobility aid bracket, thereby locking or loosening the wheels.

In order to make the mobility aid more convenient to carry and save space during daily storage, some of the current mobility aids are designed to be foldable and telescopic. The brake cable of the foldable mobility aid is exposed on the outside of the frame; at the same time, because the brake cable arranged on the mobility aid bracket is not retractable, the excessively long brake cable may catch obstacles or the human body during the use of the mobility aid, which may cause danger; while a brake cable that is too short will interfere with the folding and retracting process of the mobility aid.

Therefore, a brake cable take-up device of folding mobility aids needs to be studied to solve the above problems.

### SUMMARY OF THE INVENTION

The purpose of the invention is to provide a brake cable take-up device of folding mobility aids hidden inside the frame, which overcomes the above defects and prevents the folding and expansion process of the mobility aid from being interfered by the length of the brake cable.

In order to solve the above technical problems, the technical solutions provided by the invention are: a brake cable take-up device of folding mobility aids, comprising a frame, a brake cable, and a cable take-up device arranged on the frame, wherein the cable take-up device comprises a first pin shaft, a coil spring, and a second pin shaft; the first pin shaft and the second pin shaft are arranged on the frame with a gap; the coil spring comprises an inner end and an outer end; the inner end is rotatably sleeved on the first pin shaft; the outer end is provided with a pulling ring; the brake cable extends from one end of the frame to the cable take-up device, and is movably wound around the second pin shaft and the pulling ring and then extends to the other end of the frame.

Further, the outside of the second pin shaft is rotatably sleeved with a sleeve, and the brake cable is wound around the sleeve.

Further, the frame comprises a longitudinal pipe; the brake cable passes through the longitudinal pipe, and the cable take-up device is arranged in the longitudinal pipe.

Further, the upper end of the longitudinal pipe is connected with a handlebar, and the lower end of the longitudinal pipe is connected with a horizontal pipe; the horizontal pipe is provided with a brake; one end of the brake cable is connected to the handlebar, and the other end thereof is connected to the brake; the longitudinal pipe comprises an inner longitudinal pipe and an outer longitudinal pipe that is slidably sleeved outside the inner longitudinal pipe; the cable take-up device is arranged in the inner longitudinal pipe or the outer inner longitudinal pipe.

Further, the upper end of the longitudinal pipe is connected with a handlebar, and the lower end of the longitudinal pipe is hinged with a horizontal pipe, so that the longitudinal pipe can be folded toward the rear end of the horizontal pipe; the rear end of the horizontal pipe is provided with a brake; one end of the brake cable is connected to the handlebar, and the other end thereof is connected to the brake; the brake cable passes through the longitudinal pipe and enters the horizontal pipe, extends to the front end of the horizontal pipe and then folds back to the rear end of the horizontal pipe, and then is connected to the brake.

Further, the horizontal pipe is provided with a stop pin; the brake cable extends to the front end of the horizontal pipe and bypasses the stop pin, then folds back to the rear end of the horizontal pipe, and then is connected to the brake.

After adopting the above structure, the invention has the following advantages: when the brake cable is pulled outside the two ends of the frame, the brake cable between the pulling ring and the second pin shaft is tightened, and then the brake cable pulls the pulling ring close to the second pin shaft, and pulls the coil spring to relax and release; then the distance between the pulling ring and the second pin shaft is reduced, and the brake cable wound between the pulling ring and the second pin is released; when the pulling force is eliminated, the coil spring is reset under the action of the elastic force, and the pulling ring pulls the brake cable to recover, which realizes the retracting and releasing of the brake cable. When the frame is folded, the brake cable extends from top to bottom to the middle of the horizontal pipe and then extends toward the front wheel, bypasses the front of the stop pin and folds back, then passes through the horizontal pipe to reach the brake; the brake cable forms a circuitous section in front of the stop pin, which realizes the flexible retracting and releasing of the brake cable.

### BRIEF DESCRIPTION OF THE PREFERRED EMBODIMENTS

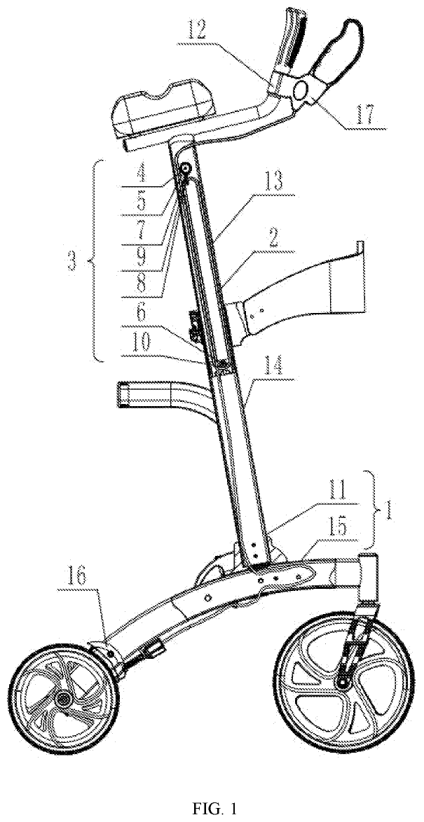

FIG. 1 is a schematic diagram of the structure of a brake cable take-up device of folding mobility aids according to the invention.

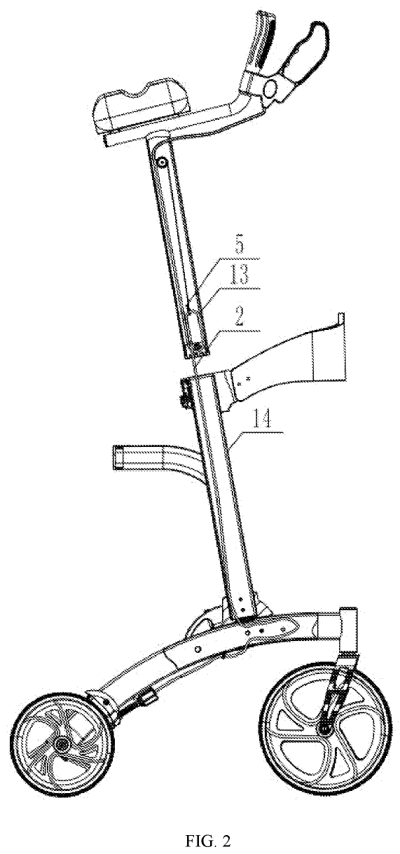

FIG. 2 is a schematic diagram of the structure of a brake cable take-up device of folding mobility aids according to the invention when the inner longitudinal pipe and the outer longitudinal pipe are separated.

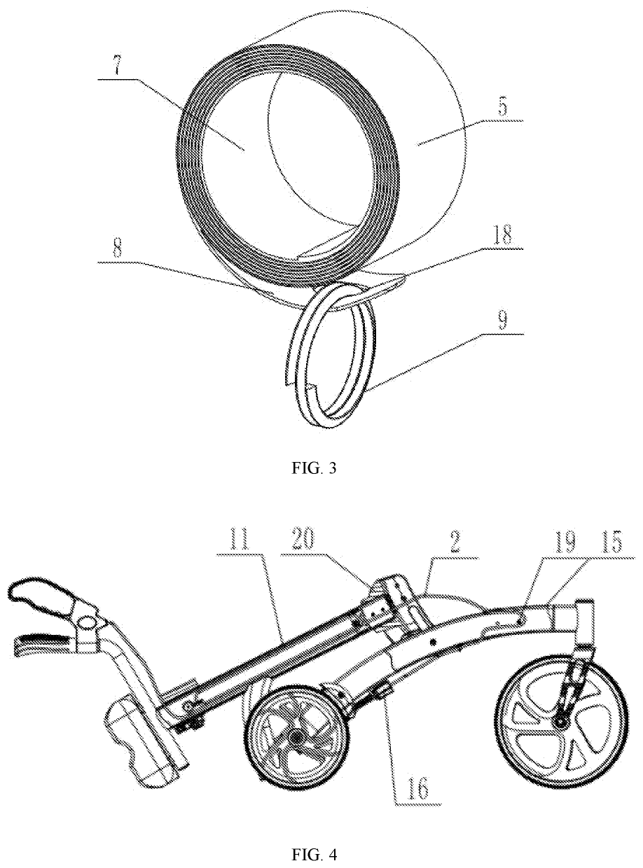

FIG. 3 is a schematic diagram of the structure of the connection of the coil spring and the pulling ring of a brake cable take-up device of folding mobility aids according to the invention.

FIG. 4 is a schematic diagram of the structure of a brake cable take-up device of folding mobility aids according to the invention when it is laid down.

In the figures, 1 refers to the frame; 2 refers to the brake cable; 3 refers to the cable take-up device; 4 refers to the first pin shaft; 5 refers to the coil spring; 6 refers to the second pin shaft; 7 refers to the inner end; 8 refers to the outer end; 9 refers to the pulling ring; 10 refers to the sleeve; 11 refers to the longitudinal pipe; 12 refers to the handlebar; 13 refers to the inner longitudinal pipe; 14 refers to the outer longitudinal pipe; 15 refers to the horizontal pipe; 16 refers to the brake; 17 refers to the brake handle; 18 refers to the pulling ring fixing hole; 19 refers to the stop pin; 20 refers to the hinged arm.

### DETAILED DESCRIPTION OF THE PREFERRED EMBODIMENTS

With reference to FIG. 1-4, the invention provides a brake cable take-up device of folding mobility aids, comprising a frame 1, a brake cable 2, and a cable take-up device 3 arranged on the frame 1, wherein the cable take-up device 3 comprises a first pin shaft 4, a coil spring 5, and a second pin shaft 6; the first pin shaft 4 and the second pin shaft 6 are arranged on the frame 1 with a gap; the coil spring 5 comprises an inner end 7 and an outer end 8; the inner end 7 is rotatably sleeved on the first pin shaft 4; the outer end 8 is provided with a pulling ring 9; the brake cable 2 extends from one end of the frame 1 to the cable take-up device 3, and is movably wound around the second pin shaft 6 and the pulling ring 9 and then extends to the other end of the frame 1.

Preferably, the first pin shaft 4 and the second pin shaft 6 are arranged in order from the upper end to the lower end on the frame; the brake cable 2 extends downwards to the second pin shaft 6 at the upper end of the frame 1, and extends upwards around the pulling ring 9 after being wound around the second pin shaft 6, and then extends downward again to the lower end of the frame 1 after being wound around the pulling ring 9.

Preferably, the outside of the second pin shaft 6 is rotatably sleeved with a sleeve 10, and the brake cable 2 is wound around the sleeve 10.

Preferably, the frame 1 comprises a longitudinal pipe 11; the brake cable 2 passes through the longitudinal pipe 11 from top to bottom; the cable take-up device 3 is arranged in the longitudinal pipe 11; the upper end of the longitudinal pipe 11 is connected with a handlebar 12; the handlebar 12 comprises a brake handle 17; one end of the brake cable 2 is fixedly connected to the brake handle 17; the lower end of the longitudinal pipe 11 is connected with a horizontal pipe 15, and the horizontal pipe 15 is provided with a brake 16; the other end of the brake cable 2 is connected to the brake 16; the longitudinal pipe 11 comprises an inner longitudinal pipe 13 and an outer longitudinal pipe 14 that is slidably sleeved outside the inner longitudinal pipe 13; the cable take-up device 3 is arranged in the inner longitudinal pipe 13 or the outer inner longitudinal pipe 14.

Preferably, the lower end of the longitudinal pipe 11 is hinged with a horizontal pipe 15; a hinged arm 20 is provided between the longitudinal pipe 11 and the horizontal pipe 15; one end of the hinged arm 20 is fixed on the longitudinal pipe 11; the hinged arm 20 is pivotally connected to the horizontal pipe 15 at one end of the side of the longitudinal tube 11, so that the longitudinal pipe 11 can be folded toward the rear end of the horizontal pipe 15; the rear end of the horizontal pipe 15 is provided with a brake 16; the cable wire 2 passes through the longitudinal pipe 11 and enters the horizontal pipe 15, extends to the front end of the horizontal pipe 15 and then folds back to the rear end of the horizontal pipe 15, and then is connected to the brake 16.

Preferably, the horizontal pipe 15 is provided with a stop pin 19; the brake cable 2 extends to the front end of the horizontal pipe 15 and bypasses the stop pin 19, then folds back to the rear end of the horizontal pipe 15, and then is connected to the brake 16.

In specific implementation of the invention, when the upper and lower ends of the frame are pulled in a direction away from the frame, the brake cable is tightened to pull the pulling ring; the pulling ring drives the coil spring to be released, and the distance between the second pin shaft and the pulling ring is reduced, so that the brake cable between the second pin shaft and the pulling ring is released. When the pulling force of the brake cable is eliminated, the coil spring is restored under the action of the elastic force, the distance between the second pin shaft and the pulling ring is restored, and the brake cable is retracted.

When the mobility aid needs to be folded, the inner longitudinal pipe is inserted into the outer longitudinal pipe from above, and the inner longitudinal pipe is disassembled from the outer longitudinal pipe to realize the folding of the handlebar; during the folding process, the relative position of the inner longitudinal pipe and the outer longitudinal pipe is changed, and the brake cable passing through the inner longitudinal pipe and the outer longitudinal pipe is retracted and released to prevent the brake cable from interfering with the folding of the frame.

When the longitudinal pipe is erected, push the brake cable under the longitudinal pipe into the horizontal pipe, and then the folding place of the brake cable is moved forward; when the longitudinal pipe is laid down, the longitudinal pipe pulls out part of the brake cable in the horizontal pipe, and then the folding place of the brake cable is moved backward.

Finally, it should be noted that the above embodiments are only used to illustrate the technical solutions of the invention and not to limit them. Although the invention is described in detail with reference to the preferred embodiments, those of ordinary skill in the art should understand that modifications or equivalent substitutions can be made to the technical solutions of the invention without departing from the purpose and scope of the technical solutions, which should be covered by the scope of the claims of the invention.

1. A brake cable take-up device of folding mobility aids, comprising a frame (1), a brake cable (2), and a cable take-up device (3) arranged on the frame (1), wherein the cable take-up device (3) comprises a first pin shaft (4), a coil spring (5), and a second pin shaft (6); the first pin shaft (4) and the second pin shaft (6) are arranged on the frame (1) with a gap; the coil spring (5) comprises an inner end (7) and an outer end (8); the inner end (7) is rotatably sleeved on the first pin shaft (4); the outer end (8) is provided with a pulling ring (9); the brake cable (2) extends from one end of the frame (1) to the cable take-up device (3), and is movably wound around the second pin shaft (6) and the pulling ring (9) and then extends to the other end of the frame (1).

2. The brake cable take-up device of folding mobility aids according to claim 1, wherein the outside of the second pin shaft (6) is rotatably sleeved with a sleeve (10), and the brake cable (2) is wound around the sleeve (10).

3. The brake cable take-up device of folding mobility aids according to claim 1, wherein the frame (1) comprises a longitudinal pipe (11); the brake cable (2) passes through the longitudinal pipe (11), and the cable take-up device (3) is arranged in the longitudinal pipe (11).

4. The brake cable take-up device of folding mobility aids according to claim 3, wherein the upper end of the longitudinal pipe (11) is connected with a handlebar (12), and the lower end of the longitudinal pipe (11) is connected with a horizontal pipe (15); the horizontal pipe (15) is provided with a brake (16); one end of the brake cable (2) is connected to the handlebar (12), and the other end thereof is connected to the brake (16); the longitudinal pipe (11) comprises an inner longitudinal pipe (13) and an outer longitudinal pipe (14) that is slidably sleeved outside the inner longitudinal pipe (13); the cable take-up device (3) is arranged in the inner longitudinal pipe (13) or the outer inner longitudinal pipe (14).

5. The brake cable take-up device of folding mobility aids according to claim 3, wherein the upper end of the longitudinal pipe (11) is connected with a handlebar (12), and the lower end of the longitudinal pipe (11) is hinged with a horizontal pipe (15), so that the longitudinal pipe (11) can be folded toward the rear end of the horizontal pipe (15); the rear end of the horizontal pipe (15) is provided with a brake (16); one end of the brake cable (2) is connected to the handlebar (12), and the other end thereof is connected to the brake (16); the brake cable (2) passes through the longitudinal pipe (11) and enters the horizontal pipe (15), extends to the front end of the horizontal pipe (15) and then folds back to the rear end of the horizontal pipe (15), and then is connected to the brake (16).

6. The brake cable take-up device of folding mobility aids according to claim 5, wherein the horizontal pipe (15) is provided with a stop pin (19); the brake cable (2) extends to the front end of the horizontal pipe (15) and bypasses the stop pin (19), then folds back to the rear end of the horizontal pipe (15), and then is connected to the brake (16).
